(19) United States
(12) Patent Application Publication
(10) Pub. No.: US 2025/0274241 A1
(43) Pub. Date: Aug. 28, 2025

(54) UPLINK DC LOCATION SIGNALING OPTIMIZATION

(71) Applicant: Nokia Technologies Oy, Espoo (FI)

(72) Inventors: Hiromasa UMEDA, Tokyo (JP); Tero HENTTONEN, Espoo (FI); Petri Juhani VASENKARI, Turku (FI)

(21) Appl. No.: 18/858,131

(22) PCT Filed: Apr. 18, 2023
(86) PCT No.: PCT/EP2023/059985

§ 371 Date: Oct. 18, 2024

Related U.S. Application Data
(60) Provisional application No. 63/363,437, filed on Apr. 22, 2022.

(51) Int. Cl. H04L 5/00; H04W 64/00

(52) U.S. Cl. CPC H04L 5/0053; H04L 5/001; H04L 5/0098; H04W 64/003

(57) ABSTRACT

Techniques of reporting UL DC location involve excluding UL DC locations when they are outside the area network is interested in (e.g., outside a configured frequency range or outside frequency range of current serving cells). That is, the network may indicate to UE in a request to only provide UL DC locations if they are 1) inside a specific frequency range or 2) outside a specific frequency range. The request may identify a criterion by which the UL DC locations are to be excluded from reporting.

### RELATED APPLICATIONS

This application claims priority to Provisional Patent Application No. 63/363,437, filed Apr. 22, 2022, entitled “UPLINK DC LOCATION SIGNALING OPTIMIZATION,” the entirety of which is hereby incorporated by reference.

### TECHNICAL FIELD

This description relates to telecommunications systems.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's LTE upgrade path for mobile networks. In LTE, base stations or access points (APs), which are referred to as enhanced Node AP (eNBs), provide wireless access within a coverage area or cell. In LTE, mobile devices, or mobile stations are referred to as user equipment (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, e.g., above 6 GHz. For fifth generation wireless systems (5G), an access architecture for deployment of cellular radio equipment employing mmWave radio spectrum has been proposed. Other example spectrums may also be used, such as cmWave radio spectrum (e.g., 3-30 GHz).

### SUMMARY

According to an example implementation, a method includes receiving, by a user device in a wireless network from a network node in the wireless network, a request to provide a location of an uplink direct current subcarrier, the request identifying a criterion for which the user device is to exclude the location of the uplink direct current subcarrier in a report to the network node.

According to an example implementation, an apparatus includes at least one processor and at least one memory including computer program code, the at least one memory and the computer program code configured to, with the at least one processor, cause the apparatus at least to receive, by a user device in a wireless network from a network node in the wireless network, a request to provide a location of an uplink direct current subcarrier, the request identifying a criterion for which the user device is to exclude the location of the uplink direct current subcarrier in a report to the network node.

According to an example implementation, an apparatus includes means for receiving, by a user device in a wireless network from a network node in the wireless network, a request to provide a location of an uplink direct current subcarrier, the request identifying a criterion for which the user device is to exclude the location of the uplink direct current subcarrier in a report to the network node.

According to an example implementation, a computer program product includes a computer-readable storage medium and storing executable code that, when executed by at least one data processing apparatus, is configured to cause the at least one data processing apparatus to receive, by a user device in a wireless network from a network node in the wireless network, a request to provide a location of an uplink direct current subcarrier, the request identifying a criterion for which the user device is to exclude the location of the uplink direct current subcarrier in a report to the network node.

According to an example implementation, a method includes transmitting, by a network node in a wireless network to a set of user devices in the wireless network, a request to provide a location of an uplink direct current subcarrier, the request identifying a criterion for which each of the user devices is to exclude the location of the uplink direct current subcarrier in a report to the network node.

According to an example implementation, an apparatus includes at least one processor and at least one memory including computer program code, the at least one memory and the computer program code configured to, with the at least one processor, cause the apparatus at least to transmit, by a network node in a wireless network to a set of user devices in the wireless network, a request to provide a location of an uplink direct current subcarrier, the request identifying a criterion for which each of the user devices is to exclude the location of the uplink direct current subcarrier in a report to the network node.

According to an example implementation, an apparatus includes means for transmitting, by a network node in a wireless network to a set of user devices in the wireless network, a request to provide a location of an uplink direct current subcarrier, the request identifying a criterion for which each of the user devices is to exclude the location of the uplink direct current subcarrier in a report to the network node.

According to an example implementation, a computer program product includes a computer-readable storage medium and storing executable code that, when executed by at least one data processing apparatus, is configured to transmit, by a network node in a wireless network to a set of user devices in the wireless network, a request to provide a location of an uplink direct current subcarrier, the request identifying a criterion for which each of the user devices is to exclude the location of the uplink direct current subcarrier in a report to the network node.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a digital communications network according to an example implementation.

FIG. 2 is a diagram illustrating direct current (DC) locations for different bandwidth parts (BWP), according to an example implementation.

FIG. 3A is a diagram illustrating a cell with four BWPs, using different DC locations for each BWP, according to an example implementation.

FIG. 3B is a diagram illustrating a cell with four BWPs, using the same DC location for all BWPs, according to an example implementation.

FIG. 4 is a diagram illustrating a default DC location and offset, according to an example implementation.

FIG. 5 is a diagram illustrating which DC location information UEs are required to report or exclude from reporting, according to an example implementation.

FIG. 6 is a diagram illustrating per-UE carrier numbering, according to an example implementation.

FIG. 7 is a flow chart illustrating a process of excluding DC locations from reporting, according to an example implementation.

FIG. 8 is a flow chart illustrating a process of excluding DC locations from reporting, according to an example implementation.

FIG. 9 is a block diagram of a node or wireless station (e.g., base station/access point, relay node, or mobile station/user device) according to an example implementation.

### DETAILED DESCRIPTION

The principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

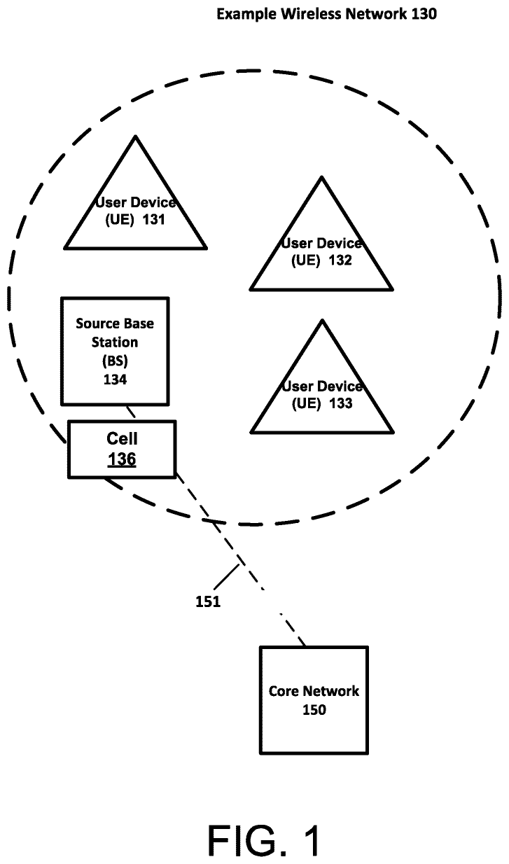

FIG. 1 is a block diagram of a digital communications system such as a wireless network 130 according to an example implementation. In the wireless network 130 of FIG. 1, user devices 131, 132, and 133, which may also be referred to as mobile stations (MSs) or user equipment (UEs), may be connected (and in communication) with a base station (BS) 134, which may also be referred to as an access point (AP), an enhanced Node B (eNB), a gNB (which may be a 5G base station) or a network node. At least part of the functionalities of an access point (AP), base station (BS) or (e) Node B (eNB) also may be carried out by any node, server or host which may be operably coupled to a transceiver, such as a remote radio head. BS (or AP) 134 provides wireless coverage within a cell 136, including the user devices 131, 132 and 133. Although only three user devices are shown as being connected or attached to BS 134, any number of user devices may be provided. BS 134 is also connected to a core network 150 via an interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/serving cell change of user devices between BSs, one or more gateways that may forward data and control signals between the BSs and packet data networks or the Internet, and other control functions or blocks.

The various example implementations may be applied to a wide variety of wireless technologies, wireless networks, such as LTE, LTE-A, 5G (New Radio, or NR), cmWave, and/or mmWave band networks, or any other wireless network or use case. LTE, 5G, cmWave and mmWave band networks are provided only as illustrative examples, and the various example implementations may be applied to any wireless technology/wireless network. The various example implementations may also be applied to a variety of different applications, services or use cases, such as, for example, ultra-reliability low latency communications (URLLC), Internet of Things (IoT), time-sensitive communications (TSC), enhanced mobile broadband (eMBB), massive machine type communications (MMTC), vehicle-to-vehicle (V2V), vehicle-to-device, etc. Each of these use cases, or types of UEs, may have its own set of requirements.

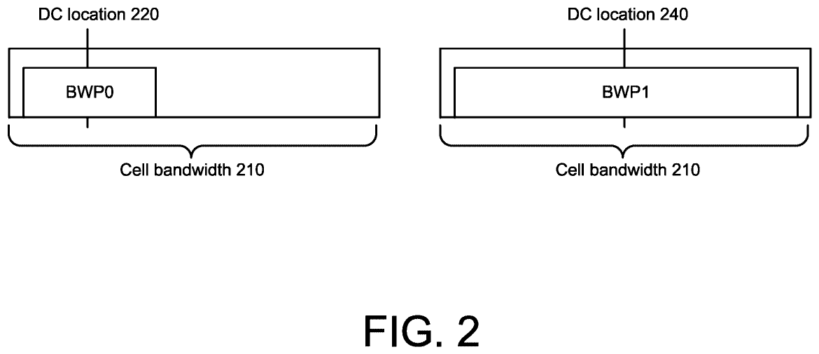

The UL Direct Current (DC) subcarrier in OFDM is a subcarrier that is not usable for data transmission. As the DC location may vary depending on which UL BWP is used, NR Rel-15 has defined UE reporting to network to indicate what the DC location is per BWP, as exemplified in FIG. 2.

FIG. 2 is a diagram illustrating direct current (DC) locations for different bandwidth parts (BWP). For example, the DC location for the BWP labelled “BWP0” within the cell bandwidth 210 is in the center of BWP0. Similarly, the DC location for the BWP labelled “BWP1” within the cell bandwidth 210 is in the center of BWP1.

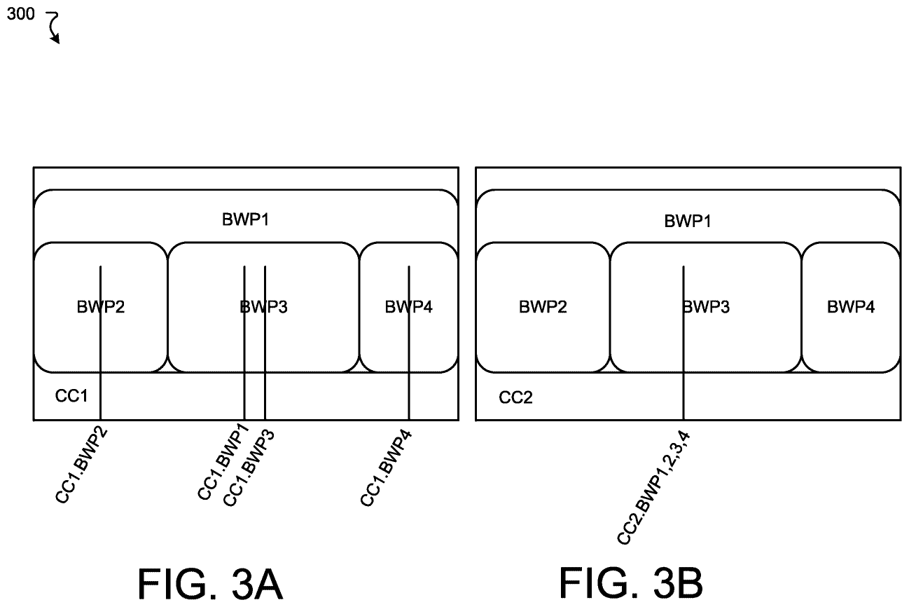

The UE is not required to report a specific DC location (e.g., center of usable frequency in the cell bandwidth, see FIG. 3A) for any BWP, and can report any DC location it wishes to use: This may be the center frequency of each BWP as shown in FIG. 2, but it may also be the same DC carrier for all BWPs (see FIG. 3B), depending on the RF configuration the UE uses. The UE may also indicate that the DC location is “outside carrier” (i.e., not within the configured channel bandwidth) or “unknown” (i.e., the DC location is unknown, which means UE is either not capable of reporting the DC location information or the information is not available). It should be noted that Rel-15 specification does not allow the UE to report a DC location for UL carrier aggregation (CA) case and/or multiple DC locations.

FIG. 3A is a diagram illustrating a cell with four BWPs: BWP1, BWP2, BWP3, and BWP4, using different DC locations for each BWP: CC1.BWP1, CC1.BWP2, CC1.BWP3, and CC1.BWP4. FIG. 3B is a diagram illustrating a cell with four BWPs: BWPs BWP1, BWP2, BWP3, and BWP4, using the same DC location (CC.BWP1,2,3,4) for all BWPs.

In Rel-16, 3GPP developed specifications to allow UE to report up to two DC locations for UL CA cases, which means the UE may report one or two DC locations for UL CA cases. In Rel-17, further enhancement of UL DC location reporting mechanism addressed allowing UE to report up to two DC locations to deal with CA with two and more CCs. 3GPP, however, faced a challenge that DC location is affected by various factors such that the outer edges of the outer activated or configured BWPs or activated or configured CCs. It means that if three contiguous CCs (CC1, 2 and 3 from the left) are configured, a DC location when CC1 and CC3 are activated and a DC location when CC1 and CC2 are activated, can be different. It is possible to configure one CC with up to four BWPs, signaling needs to take into account all the permutations of active or configured BWPs, and activated or activated CCs. Since this does significantly increase the amount of signaling overhead, a solution was sought.

Considering that a UE needs to meet out of band emission requirements, it is likely that a DC location is at center between the lower edge of lower BWP or CC and the upper edge of upper BWP or CC within a CA. Note that BWP or CC may be activated, inactivated or configured one. The virtue of such a solution is as far as the UE follows this principle, the UE does not have to report its DC location explicitly (permutations themselves are not reported or permutations are reported with offset range from the default DC location as absence) and it saves the amount of signaling.

3GPP agreed to define a default UL DC location which is in the middle of the UE bandwidth that is frequencies between lower edge of lowest frequency component and upper edge of highest frequency component which can be one of the activated carrier component, configured carrier component, activated BWP and configured BWP.

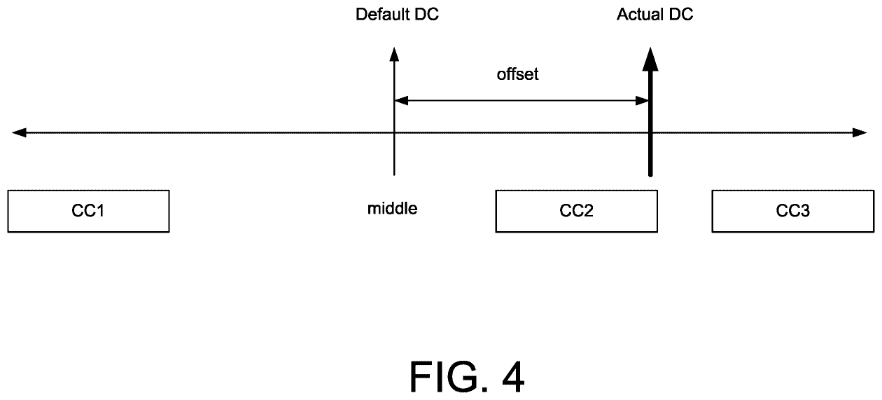

With respect to the above default UL DC location, in order to provide UE with implementation flexibility, an exception, i.e., a DC location is positioned at somewhere other than default DC location, is allowed. Thus far, 3GPP agreed to treat this exception in a way that UE is allowed to signal offset from the default DC location if necessary, e.g., as shown in FIG. 4.

FIG. 4 is a diagram illustrating a default DC location and offset. As shown in FIG. 4, there are three CCs, CC1, CC2, and CC3. “Middle” is the default DC location where is the center of the lower edge of CC1 and the upper edge of CC3 in this example. The DC, however, is placed in CC2 and the position is indicated by the distance from the default DC location which is defined as offset. Although the use of an offset from default has been agreed, the possible values for the offset have not yet been resolved.

Up to +/−1.5 GHz as one of the largest range considering that the band with widest pass-bandwidth has around 3 GHz width in FR2-1 and up to +/−20 MHz as the smallest range have been proposed in RAN4 while no consensus has been made. A continuous no consensus mainly comes from a trade-off between signaling overhead vs UE implementation flexibility.

The +/−1.5 GHz signal offset will be called option 1 and the +/−20 MHz option 2 hereafter.

### Problem 1: Signaling Overhead

Assuming the number of CCs can be as many as 16 and considering the introduction of a new band in even higher frequency range (as is done in 3GPP Rel-17, where the FR2 frequency area is extended with frequencies between 52.6 GHz and 71 GHZ), the situation will become worse than before. For instance, n263 will be introduced in Rel-17 and its full pass-bandwidth is 24 GHZ (57-71 GHz) where the minimum channel bandwidth is 400 MHz and that is also the only mandatory channel bandwidth for 120 kHz SCS. The other channel bandwidths for higher SCSs are optional. Given that it is likely that this band is used for unlicensed operation, up to 60 CCs could be possible at most. Now the number of CC permutations to take two out of 60 is (₂⁶⁰)=1,770, where each of the CCs can be configured with up to four BWPs, the number of permutations is 28,320.

If option 1 is taken (i.e., maximum offset frequency range), that max offset value would be 12 GHz, where SCS may be 120 kHz. Then, the number of points to indicate DC location is 100,000 points, which requires 17 bits per permutation. Hence, one band combination requires 28,320×17=481,440 bits in total for a UE to report its DC locations. If option 2 is taken (i.e., +/−20 MHz with 120 kHz SCS), then DC location requires 166 points, which requires 8 bits. Since a 20 MHz offset may come from 60 kHz SCS, we can scale the number of 166 to 332 for fairness. Then, the required number of bits is 9 for option 2. The number of the permutations is common, but even then, the total amount of bits per band combination is 28,320×9=254,880 bits.

In summary, the number of required bits per band combination for option 1 and option 2 is 481,440 bits (˜481 kbits or ˜60 kBytes) and 254,880 bits (˜254 kbits or ˜31 kBytes), respectively.

Since this is not a UE capability, a UE is required to report these values whenever asked by a network. And the instances when UE could be requested to provide such report will likely only increase in the future due to the following reasons.
UL enhancement is one of the most important items in Rel-18 and beyond and hence, features more sensitive to UL quality will be used more frequently, e.g., UL 256QAM for FR2 and UL 1024 QAM for FR1.
The mmWave frequencies are even more sensitive than the sub-6 GHz frequencies to UL quality due to excessive phase noise.
A new feature may require information where UL DC location is, e.g., to identify the applicable A-MPR or suitable UL transmission bandwidth configuration.

Overall, the network may need to request UE to report DC locations more often than before. Hence, the trade-off between more signaling overhead and performance improvement should be addressed.

### Problem 2: UL Signal Quality Handling

At this point, adopting the option 2 (+/−20 MHz offset range) in 3GPP would seem the better choice to avoid excessive signaling overhead because it was considered that allowing UE implementation flexibility in terms of DC location reporting would not provide benefits for network operation. TS 38.331, however, already allows UE to report a value 3301, which indicates “Undetermined position within the carrier”. Hence, restriction of UE implementation may lead UE to report 3301 even though a DC falls within a carrier among CCs for a CA due to lack of sufficient offset range. On the other hand, to enhance UL coverage, performance requirements for UL 256QAM for FR2 will be discussed in Rel-18 and those for UL 1024 QAM for FR1 were introduced in Rel-17. Increasing possibility for a UE to report 3301 may become an obstacle to make these UL enhancement features popular in the real market since the UL quality degradation due to lack of exact DC location may prevent UEs from performing at its full potential.

In contrast to the above-cited conventional approaches to reporting DC locations, improved techniques involve excluding UL DC locations when they are outside the frequency range that network is interested in (e.g., outside a configured frequency range or outside frequency range of current serving cells). That is, the network may indicate to UE in a request to only provide UL DC locations if they are 1) inside a specific frequency range, or 2) outside a specific frequency range. The request may identify a criterion by which the UL DC locations are to be excluded from reporting.

It is noted that, in the context of the subject matter herein, that a frequency range may include multiple, non-contiguous frequency intervals. For example, a specific frequency range can be the frequency ranges corresponding to multiple non-adjacent CCs.

In some implementations, the criterion includes whether an operating frequency range includes a specific frequency range. In some implementations, the criterion includes whether an operating frequency range is outside of a frequency range of a current serving cell. In some implementations, the criterion includes whether an operating frequency range is outside of a specific frequency range. In this last case, in some implementations the operating frequency range may include a carrier aggregation. The above improved techniques involve a set of carrier components where each of the carrier components covers a respective component frequency range; in this case, the request includes identifiers for each of the set of carrier components. In some implementations, the identifiers include respective reference numbers for each of the set of carrier components.

Advantageously, the improved techniques make improvements to both signaling overhead and flexibility in UE implementation.

It is shown that the UE can exclude a DC location when the DC location is outside of the frequency range in which network is interested (e.g., outside a configured frequency range or outside frequency range of current serving cells). That is, the network may indicate to UE to only provide DC locations if they are 1) inside a specific frequency range or 2) outside a specific frequency range. This can be indicated partly via the existing DC location signaling, i.e., the code points 3300 (“outside the carrier”) and 3301 (“undetermined position within the carrier”), or via specific new code points in the signaling and can including reference to the CC where the UL DC is positioned (based on CC numbering provided by the network).

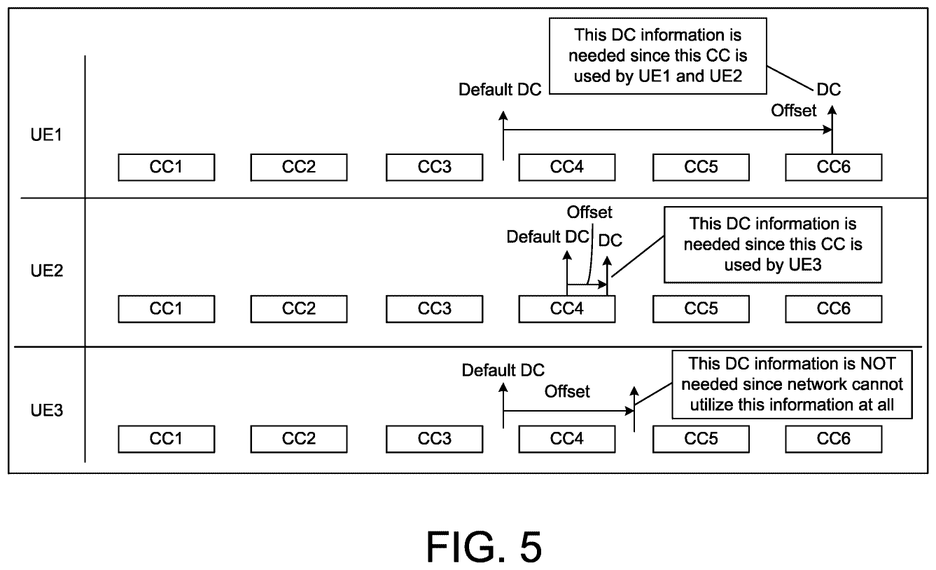

FIG. 5 is a diagram illustrating which DC location information UEs are required to report or exclude from reporting. FIG. 5 shows three UEs, UE1, UE2, and UE3. Each UE may be configured using different carriers: UE1 uses CC1 and CC6, UE2 uses CC2 and CC6 and UE3 uses CC2, CC3, CC4, and CC5. Each UE may also refer to these based on only its own configuration, which is only based on the UE carrier configuration. However, since the network determines the operating carriers, each of the three UEs may be assigned to use the same numbering for the 6 CCs: CC1, CC2, CC3, CC4, CC5, and CC6. The network indicates to the UE for each CC what the “reference number” for each configured CC should be. For UE1, the UL DC location is offset from the default location and is at the center of CC6; for UE1, the UL DC location information is needed since CC6 is used by UE1 and UE2. For UE2, the UL DC location is offset from the default location in the center of CC4, but is toward an end of the frequency range of CC4; for UE2, the UL DC location information is needed since CC4 is used by UE3. For UE3, the UL DC location is offset from the default location and is at a frequency not used in any of the CCs; this UL DC location is not used because the network cannot use that information.

A root cause to an increased number of bits for an offset range from a default DC location originates with distance being continuous from the point of origin. However, in terms of network operation, a UL DC location being outside carrier components being used by a network is typically irrelevant to network quality as shown in FIG. 5. What matters is whether the carrier causes interference to a frequency used by the network (even if it is for another UE). In addition, the network may not always need all the UL DC locations information from the UE. For example, a network may use higher order modulation for only some of the CCs under the network at a given time instance, so there may not necessarily be a need to express the DC location by the distance from the default DC location. And the network may not need DC location information falling some of the CCs under the network especially if those CCs are not used by the UE sending UL DC report.

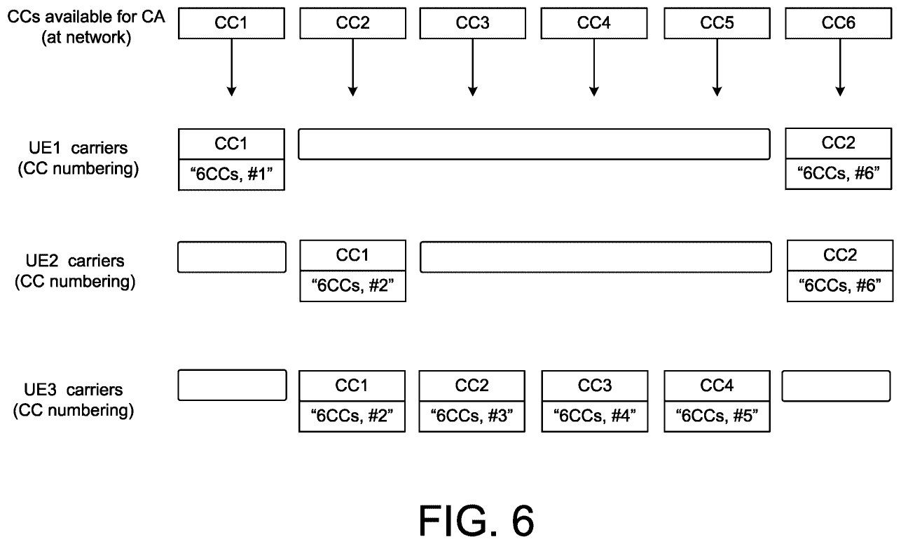

Accordingly, the improved techniques include, in some implementations:
The network defines reference numbers n (1, 2, . . . m) for all the CCs to be available for a CA, including potentially information on the size of the CCs. This is already partly depicted in FIG. 5 and shown in additional detail in FIG. 6.
The network requests a UE to report DC locations to either 1) fall into the CCs that the network designated with the reference number(s) OR 2) do NOT fall into the CCs that the network designated with the reference numbers. This kind of network filtering allows for signaling optimizations for various contiguous and non-contiguous cases.
   The UE to report DC location(s) per permutations for the respective reference number(s) with the same method defined in Rel-15 and 16 that uses 12 bits (4096) per BWP/CC or with a method using default UL DC location with an offset frequency.
The network can know the exact UL DC location from the information consisting of the reference number for the CC with DC location and the exact DC location position within the CC.

FIG. 6 is a diagram illustrating per-UE carrier numbering. As in FIG. 5, FIG. 6 shows three UEs, UE1, UE2, and UE3. Each UE may be configured using different carriers: UE1 uses CC1 and CC6, UE2 uses CC2 and CC6 and UE3 uses CC2, CC3, CC4, and CC5. Each UE may also refer to these based on only its own configuration, which is only based on the UE carrier configuration. However, since the network determines the operating carriers, each of the three UEs may be assigned to use the same numbering for the 6 CCs: CC1, CC2, CC3, CC4, CC5, and CC6. The network indicates to the UE for each CC what the “reference number” for each configured CC should be, and can also indicate how many contiguous carrier chunks the UE should assume for the CC. The UE can then count frequencies based on the carrier reference number assuming they are contiguous. This defines a reference numbering scheme that allows network to define the carrier numbering either per UE or per network deployment (depending which is more appropriate), and allowing to append the information to each carrier allows to take non-contiguous chunks into account. Once the numbering has been defined, network can simply indicate UE to report the DC location based on the numbering. Additionally, network may request to UE report DC location if it is within certain carriers (allow-list) or the network may request to UE report DC location if it is NOT within certain carriers (block-list).

It is noted that, as an alternative to the carrier numbering, the network may explicitly share the frequency range that the network is interested in with UE, e.g., via indicating the end and start frequencies of the range.

The required bits to indicate DC location per permutation is the same as that of Rel-15 and 16, i.e., 12 bits. It means that they are less than option 1 (17 bits) while larger than option 2 (9 bits). This method, however, would be able to drastically reduce the number of bits required to indicate the number of indexes for permutations. More specifically, if maximum of two CCs (CC1 and CC2) is available in a network and the network wants to know if which UE's DCs that falls into CC2 and the respective DC positions in CC2 as shown in Table 1. It should be noted that each CC can have up to four BWPs. For instance, a permutation consisting of BWP1 in CC1 and BWP1 in CC2 is shown as (1, 1), BWP1 in CC1 and BWP2 in CC2 is shown as (1, 2) and so on in the 2nd column with index 1, 2, respectively in Table 1. Hence, the number of permutations can be 16 (4×4) at maximum. Hence the number of permutation index is 16 in the 1st column in Table 1. In this case, any information on permutations and associated information for CC1 are not reported. More specifically, with respect to Permutation index of 1, the DC falls into CC with reference number of 1 as can be seen in the right most column in Table 1. Though the exact DC position can be indicated by default DC location+offset range A, the network is not interested in DCs falling into CCs other than CC2 in this example, hence, all the information associated with index 1 does not need to be reported. With another example using permutation index of 4, the DC falls CC with reference number of 2. For this case, the DC position should be reported to the network. Since the DC for permutation index of 4 does not fall at default DC location, the UE may report the permutation index of 4 with offset C or it may report DC location for the permutation index of 4 within CC2 with 12 bits explicitly. With this, the signaling for permutations and the associated information can be reduced as well as the signaling for indication of DC position can be reduced from 17 bits to 12 bits (compared to option 1). Though the signaling for indication of DC position can a little bit larger than 9 bits of the option 2, the method still has possibility to compensate for this increase by reducing the amount of information about the permutation. Hence, this can be a good alternative to achieve the signaling overhead and UE implementation flexibility.

TABLE 1
An example scenario in which two CCs are available and the network
wants to know UL DC location information on only CC2.

| Permutation | (BWP.CC1, | | | CC index |
|---|---|---|---|---|
| Index | BWP.CC2) | DC at Default | Offset | where DC falls |
| 1 | (1, 1) | NO | A | 1 |
| 2 | (1, 2) | YES | N/A | 2-> reported |
| 3 | (1, 3) | NO | B | 1 |
| 4 | (1, 4) | NO | C | 2-> reported |
| 5 | (2, 1) | YES | N/A | 1 |
| | — | YES | N/A | |
| 8 | (2, 4) | NO | D | 1 |
| 9 | (3, 1) | YES | N/A | 2-> reported |
| | — | | | |
| 12 | (3, 4) | NO | E | 2-> reported |
| 13 | (4, 1) | YES | | 1 |
| | — | | | |
| 16 | (4, 4) | NO | | 1 |

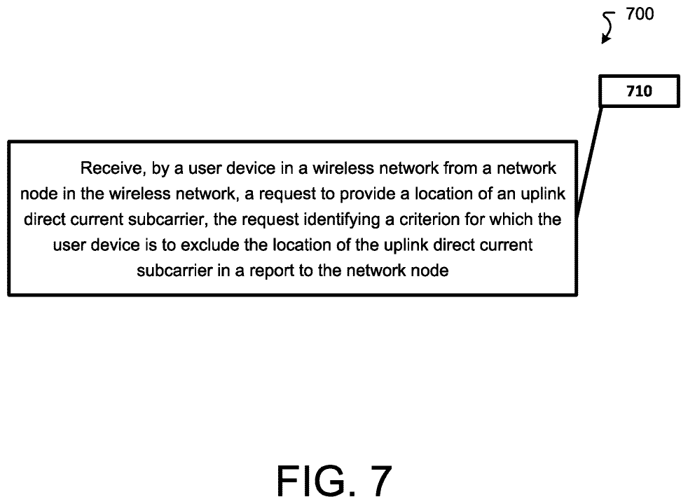

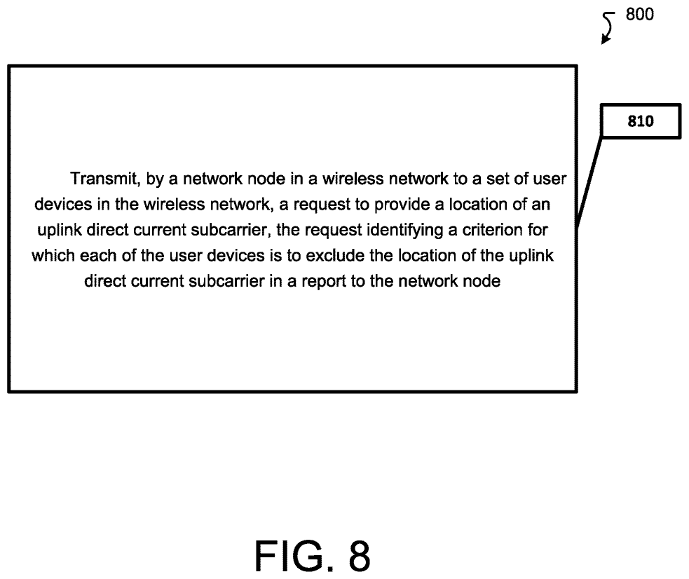

Example 1-1: FIG. 7 is a flow chart illustrating a process 700 of determining action to take upon execution of a machine learning algorithm. Operation 710 includes receiving, by a user device in a wireless network from a network node in the wireless network, a request to provide a location of an uplink direct current subcarrier, the request identifying a criterion for which the user device is to exclude the location of the uplink direct current subcarrier in a report to the network node.
Example 1-2: According to an example implementation of Example 1-1, wherein the criterion includes whether an operating frequency range includes a specific frequency range.
Example 1-3: According to an example implementation of any of Example 1-1, wherein the criterion includes whether an operating frequency range is outside of a frequency range of a current serving cell.
Example 1-4: According to an example implementation of Example 1-1, wherein the criterion includes whether an operating frequency range is outside of a specific frequency range.
Example 1-5: According to an example implementation of Example 1-4, wherein each of a set of carrier components covers a respective component frequency range, and wherein the request includes identifiers for each of the set of carrier components.
Example 1-6: According to an example implementation of Example 1-5, wherein the identifiers include respective reference numbers for each of the set of carrier components.
Example 1-7: An apparatus comprising means for performing a method of any of Examples 1-1 to 1-6.
Example 1-8: A computer program product including a non-transitory computer-readable storage medium and storing executable code that, when executed by at least one data processing apparatus, is configured to cause the at least one data processing apparatus to perform a method of any of Examples 1-1 to 1-6.
Example 2-1: FIG. 8 is a flow chart illustrating a process 800 of determining action to take upon execution of a machine learning algorithm. Operation 810 includes transmitting, by a network node in a wireless network to a set of user devices in the wireless network, a request to provide a location of an uplink direct current subcarrier, the request identifying a criterion for which each of the user devices is to exclude the location of the uplink direct current subcarrier in a report to the network node.
Example 2-2: According to an example implementation of Example 2-1, wherein the criterion includes whether an operating frequency range is outside of a specific frequency range.
Example 2-3: According to an example implementation of Example 2-2, wherein each of a set of carrier components covers a respective component frequency range, and wherein the method further comprises assigning to each carrier component of the set of carrier components a respective reference number.
Example 2-4: According to an example implementation of Example 2-2, wherein the request includes a reference number assigned to a carrier component covering a frequency range outside of the specific frequency range.
Example 2-5: According to an example implementation of Example 2-2, wherein the request includes an allow list of carrier components of the set of carrier components for which a user device may report an uplink direct current subcarrier.
Example 2-6: According to an example implementation of Example 2-2, further comprising receiving, from a user device of the set of user devices, (i) a report indicating a reference number for a carrier component of the set of carrier components and (ii) a location of the uplink direct current subcarrier within the carrier component; and determining the location of the uplink direct current subcarrier based on the reference number and the location of the uplink direct current subcarrier within the carrier component.
Example 2-7: According to an example implementation of Example 2-6, wherein a default location for the uplink direct current subcarrier is in a center of a UE frequency range that has a minimum frequency at a lowest frequency of a first carrier component of the set of carrier components and a maximum frequency of a second carrier component of the set of carrier components, each of the first and second carrier components being one of an activated carrier component, a configured carrier component, or an activated BWP and configured BWP; and wherein determining the location of the uplink direct current subcarrier includes specifying an offset of the default location of the uplink direct current subcarrier.
Example 2-8: An apparatus comprising means for performing a method of Examples 2-1 to 27.
Example 2-9: A computer program product including a non-transitory computer-readable storage medium and storing executable code that, when executed by at least one data processing apparatus, is configured to cause the at least one data processing apparatus to perform a method of Examples 2-1 to 2-7.

### List of Example Abbreviations

A-MPR Additional Maximum Power Reduction
BWP BandWidthPart
CA Carrier Aggregation
CC Carrier Component
DC Direct Current
FR Frequency Range
OFDM Orthogonal Frequency-Division Multiplexing
QAM Quadrature Amplitude Modulation
RF Radio Frequency
RRC Radio Resource Control
SCS Sub-Carrier Spacing
UE User Equipment
UL UpLink

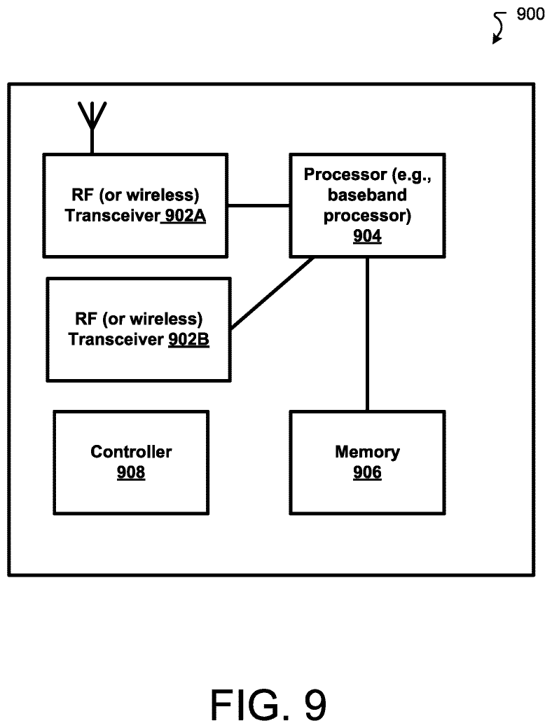

FIG. 9 is a block diagram of a wireless station (e.g., AP, BS, e/gNB, NB-IoT UE, UE or user device) 900 according to an example implementation. The wireless station 900 may include, for example, one or multiple RF (radio frequency) or wireless transceivers 902A, 902B, where each wireless transceiver includes a transmitter to transmit signals (or data) and a receiver to receive signals (or data). The wireless station also includes a processor or control unit/entity (controller) 904 to execute instructions or software and control transmission and receptions of signals, and a memory 906 to store data and/or instructions.

Processor 904 may also make decisions or determinations, generate slots, subframes, packets or messages for transmission, decode received slots, subframes, packets or messages for further processing, and other tasks or functions described herein. Processor 904, which may be a baseband processor, for example, may generate messages, packets, frames or other signals for transmission via wireless transceiver 902 (902A or 902B). Processor 904 may control transmission of signals or messages over a wireless network, and may control the reception of signals or messages, etc., via a wireless network (e.g., after being down-converted by wireless transceiver 902, for example). Processor 904 may be programmable and capable of executing software or other instructions stored in memory or on other computer media to perform the various tasks and functions described above, such as one or more of the tasks or methods described above. Processor 904 may be (or may include), for example, hardware, programmable logic, a programmable processor that executes software or firmware, and/or any combination of these. Using other terminology, processor 904 and transceiver 902 together may be considered as a wireless transmitter/receiver system, for example.

In addition, referring to FIG. 9, a controller (or processor) 908 may execute software and instructions, and may provide overall control for the station 900, and may provide control for other systems not shown in FIG. 9 such as controlling input/output devices (e.g., display, keypad), and/or may execute software for one or more applications that may be provided on wireless station 900, such as, for example, an email program, audio/video applications, a word processor, a Voice over IP application, or other application or software.

In addition, a storage medium may be provided that includes stored instructions, which when executed by a controller or processor may result in the processor 904, or other controller or processor, performing one or more of the functions or tasks described above.

According to another example implementation, RF or wireless transceiver(s) 902A/902B may receive signals or data and/or transmit or send signals or data. Processor 904 (and possibly transceivers 902A/902B) may control the RF or wireless transceiver 902A or 902B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G uses multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks.

Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall as intended in the various embodiments.

1.-24. (canceled)

25. An apparatus, comprising:
at least one processor; and
at least one memory including computer program code;
the at least one memory and the computer program code configured to cause the apparatus at least to:
receive, by a user device in a wireless network from a network node in the wireless network, a request to provide a location of an uplink direct current subcarrier, the request identifying a criterion for which the user device is to exclude the location of the uplink direct current subcarrier in a report to the network node.

26. The apparatus as in claim 25, wherein the criterion includes whether an operating frequency range includes a specific frequency range.

27. The apparatus as in claim 25, wherein the criterion includes whether an operating frequency range is outside of a frequency range of a current serving cell.

28. The apparatus as in claim 25, wherein the criterion includes whether an operating frequency range is outside of a specific frequency range.

29. The apparatus as in claim 26, wherein each of a set of carrier components covers a respective component frequency range, and
wherein the request includes identifiers for each of the set of carrier components.

30. The apparatus as in claim 29, wherein the identifiers include respective reference numbers for each of the set of carrier components.

31. An apparatus comprising:
means for receiving, by a user device in a wireless network from a network node in the wireless network, a request to provide a location of an uplink direct current subcarrier, the request identifying a criterion for which the user device is to exclude the location of the uplink direct current subcarrier in a report to the network node.

32. An apparatus, comprising:
at least one processor; and
at least one memory including computer program code;
the at least one memory and the computer program code configured to cause the apparatus at least to:
transmit, by a network node in a wireless network to a set of user devices in the wireless network, a request to provide a location of an uplink direct current subcarrier, the request identifying a criterion for which each of the set of user devices is to exclude the location of the uplink direct current subcarrier in a report to the network node.

33. The apparatus as in claim 32, wherein the criterion includes whether an operating frequency range is outside of a specific frequency range.

34. The apparatus as in claim 33, wherein each of a set of carrier components covers a respective component frequency range, and
wherein the at least one memory and the computer program code are further configured to cause the apparatus at least to:
assign to each carrier component of the set of carrier components a respective reference number.

35. The apparatus as in claim 34, wherein the request includes a reference number assigned to a carrier component of the set of carrier components covering a frequency range outside of the specific frequency range.

36. The apparatus as in claim 34, wherein the request includes an allow list of carrier components of the set of carrier components for which a user device may report an uplink direct current subcarrier.

37. The apparatus as in claim 34, wherein the at least one memory and the computer program code are further configured to cause the apparatus at least to:
receiving, from a user device of the set of user devices, (i) a report indicating a reference number for a carrier component of the set of carrier components and (ii) a location of the uplink direct current subcarrier within the carrier component; and
determining the location of the uplink direct current subcarrier based on the reference number and the location of the uplink direct current subcarrier within the carrier component.

38. The apparatus as in claim 37, wherein a default location for the uplink direct current subcarrier is in a center of a UE frequency range that has a minimum frequency at a lowest frequency of a first carrier component of the set of carrier components and a maximum frequency of a second carrier component of the set of carrier components, each of the first and second carrier components being one of an activated carrier component, a configured carrier component, or an activated BWP and configured BWP; and
wherein determining the location of the uplink direct current subcarrier includes specifying an offset of the default location of the uplink direct current subcarrier.
